(19) United States
(12) Patent Application Publication
(10) Pub. No.: US 2016/0236520 A1
(43) Pub. Date: Aug. 18, 2016

(54) Bicycle Tire

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Luc BESTGEN, Clermont-Ferrand Cedex 9 (FR); David OLSOMMER, Clermont-Ferrand Cedex 9 (FR)

(73) Assignees: Compagnie Generale Des Etablissements Michelin, Clermont-Ferrand (FR); Michelin Recherche et Technique S,A,, Granges-Paccot (CH)

(21) Appl. No.: 15/026,178

(22) PCT Filed: Oct. 1, 2014
(86) PCT No.: PCT/EP2014/071004

§ 371 Date: Mar. 30, 2016

(30) Foreign Application Priority Data
Oct. 2, 2013 (FR) 1359538

(51) Int. Cl. B60C 13/02; B60C 15/00; B60C 11/00

(52) U.S. Cl. CPC B60C 13/02; B60C 11/00; B60C 15/00; B60C 2013/006

(57) ABSTRACT

A bicycle tire comprises a toothset (5) of substantially radial generatrix (G), positioned to collaborate with a complementary toothset of a driving pinion of an electrical assistance device. The toothset (5) has teeth (51) that are equidistant by a pitch p, each tooth having a length l, in the direction of the generatrix (G), and a substantially triangular section, in a plane perpendicular to the generatrix (G), of height h. Each tooth (51) comprises an elastomeric material having an elastic shear modulus G* at least equal to a threshold elastic shear modulus G*ₛ, G*ₛ being such that the displacement d of the crest of each tooth is equal to 0.2 times the height h of the tooth under the action of a uniform pressure, applied by the complementary toothset to the side that forms the smallest angle, equal to 650/(l×h×(2.67−0.33×p)).

The present invention relates to a bicycle tire and, more particularly, to a bicycle tire intended to collaborate with an electrical assistance device.

An electrical assistance device means an electric device mounted on the bicycle and able to drive the rotation of at least one wheel of the bicycle.

Document DE-20314210-U1 describes a principle for the driving of a bicycle using an electric assistance device or electric motor in which a driving pinion meshes with a toothset secured to the hoop of the front rim of the bicycle, said toothset being an internal toothset, which means to say a toothset the teeth of which face towards the axis of the wheel. One disadvantage with this device is that the toothset of the rim is liable to trap stones.

Documents DE-4011567-A1 and U.S. Pat. No. 5,165,776 describe an electricity generator device, for bicycle lighting, intended to collaborate with a tire comprising a toothset of radial generatrix positioned circumferentially on a sidewall of the tire and intended to collaborate with a complementary toothset of a pinion of the electricity generator device. The toothset positioned on the sidewall of the tire is designed to turn the free pinion of the electricity generator device. However, this toothset is not engineered to be driven by the driving pinion of an electrical assistance device.

One object of the invention is to propose a bicycle tire comprising a toothset of substantially radial generatrix, positioned circumferentially on a sidewall of the tire and in order to collaborate with a complementary toothset of a driving pinion of an electrical assistance device for a bicycle.

For that purpose, the invention proposes a bicycle tire comprising:
two sidewalls connecting a tread to two beads,
a continuous toothset, of generatrix substantially radial with respect to the axis of rotation of the tire of axial direction, positioned circumferentially on an axially exterior face of at least one sidewall, and intended to collaborate with a complementary toothset,
the toothset being made up of teeth that are equidistant by a pitch p,
each tooth having a length l, in the direction of the generatrix, and a substantially triangular section in a plane perpendicular to the generatrix,
the substantially triangular section comprising a first and a second side emanating from a first vertex, referred to as the crest of the tooth, and a third side opposite the first vertex and positioned on the axially exterior face of the sidewall,
the first and second sides respectively forming, with the direction perpendicular to the third side, a first and a second angle,
the distance between the crest of the tooth and its orthogonal projection onto the third side defining the height h of the tooth,
each tooth comprising an elastomeric material having an elastic shear modulus G*,
the elastic shear modulus of the elastomeric material of the teeth being at least equal to a threshold elastic shear modulus G*ₛ, the threshold elastic shear modulus G*ₛ being such that the displacement d of the crest of each tooth is equal to 0.2 times the height h of the tooth under the action of a uniform pressure P applied by the complementary toothset to the side that forms the smallest angle, equal to 650/(l×h×(2.67−0.33×p)).

A bicycle tire has an exterior geometry characterized in particular by an exterior diameter, a rim diameter, and a section height and width, all measured in a meridian plane passing through the axis of rotation of the tire. In particular, these geometric features are measured on a tire mounted on its rim and inflated to its service pressure, in accordance with the provisions of the standards of the European Tire and Rim Technical Organization or ETRTO.

The sidewalls are the lateral portions of a tire that connect the tread, intended to come into contact with the ground, to the beads, intended to come into contact with a rim.

A toothset is geometrically defined by a generatrix. In the case of a toothset according to the invention, the generatrix is substantially radial, which means to say that it makes a small angle with the radial direction of the tire, perpendicular to the axial direction of the axis of rotation of the tire. More specifically, a substantially radial generatrix makes an angle at most equal to 45° with the direction tangential to the axially exterior face of the sidewall which is situated in a meridian or radial plane of the tire perpendicular to the axis of rotation of the tire. The axially exterior face of the tire sidewall is that face of the sidewall that is in contact with the atmospheric air, as opposed to the axially interior face of the sidewall which is in contact with the air with which the tire is inflated.

In addition, this toothset is positioned circumferentially on an axially exterior face of at least one sidewall of the tire, which means to say in the circumferential direction tangential to the tread surface of the tire and oriented in the direction in which the tire runs. In addition, the toothset is continuous, which means to say that it is positioned over the entire circumference of the sidewall.

More specifically, the toothset is made up of teeth which are equidistant by a pitch p, which means to say via juxtaposition of teeth each one separated from the next by a constant distance or pitch. The pitch of the toothset is a characteristic of the ability of the toothset to mesh with a complementary toothset of a driving pinion of an electrical assistance device and in particular governs the number of teeth of the toothset that will be simultaneously in contact with the complementary toothset of the pinion in order to transmit the desired driving torque. The pitch of the toothset is also dependent on the diameter of the pinion.

Each tooth is geometrically characterized by a length l, measured along the generatrix of the toothset, and by a substantially triangular section, in a plane perpendicular to the generatrix. A substantially triangular section is a three-sided section which may have rounded vertices, which means to say vertices that are not necessarily angular, and sides which are not necessarily rectilinear. A substantially triangular section can be inscribed inside a triangular section in the mathematical sense. This substantially triangular section comprises a first and a second side emanating from a first vertex, referred to as the crest of the tooth, and a third side opposite the first vertex and positioned on the axially exterior face of the sidewall. The first and second sides respectively form, with the direction perpendicular to the third side, a first and a second angle. The distance between the crest of the tooth and its orthogonal projection onto the third side defines the height h of the tooth.

The length l of the teeth defines the maximum possible length of mesh with a complementary toothset. The height h of the teeth defines the maximum possible depth of mesh with a complementary toothset.

As far as the material of which the toothset is made is concerned, each tooth comprises an elastomeric material having an elastic shear modulus G*.

According to the invention, the elastic shear modulus G* of the elastomeric material of the teeth is at least equal to a threshold elastic shear modulus G*ₛ, the threshold elastic shear modulus G*ₛ being such that the displacement d of the crest of each tooth is equal to 0.2 times the height h of the tooth under the action of a uniform pressure applied by the complementary toothset to the side that forms the smallest angle, equal to 650/(l×h×(2.67−0.33×p)).

The elastic shear modulus G* or complex dynamic shear modulus G* is measured on a standardized test specimen using a viscoanalyzer (for example of the Metravib VA4000 make), in accordance with standard ASTM D 5992-96 at a temperature of 23° C. and with a 10% amplitude sweep.

The threshold elastic shear modulus G*ₛ is determined by calculation, using finite-element simulations, with nonlinear planar deformation modelling taking the noncompressibility of the elastomeric material of the tooth into consideration. Thus, one single tooth is modelled with the following boundary conditions: the third side positioned on the axially exterior face of the sidewall is blocked against displacement, the first or the second side, the one that has the smallest angle, is subjected to a uniform pressure equal to 650/(l×h×(2.67−0.33×p)). The elastomeric material of the tooth is an incompressible Hookean material, having a Young's modulus E* and a Poisson's ratio of 0.49. For a given Young's modulus E*, the displacement d of the vertex of the tooth can then be determined by calculation. From this the ratio d/h of the displacement of the crest of the tooth to the height of the tooth can be deduced. By repeating this process for various values of Young's modulus E* it is possible to determine a relationship between the Young's modulus E* and the ratio d/h of the displacement of the crest of the tooth to the height of the tooth. Through successive approximations, the threshold Young's modulus E*ₛ such that this ratio d/h is equal to 0.2 can then be determined. The threshold elastic shear modulus G*ₛ can then be deduced from this using the relationship G*ₛ=E*ₛ/3.

The uniform pressure P applied to the tooth in the numerical simulations is taken to be equal to 650/(l×h×(2.67−0.33×p)), P being expressed in bar. The uniform pressure P, expressed in bar, is equal to P=F×10/(S×N), where F, expressed in N, is the driving force applied by the complementary toothset of the driving pinion of the electrical assistance device to the toothset of the tire, where S, expressed in mm², is the surface area to which the driving force is applied to a tooth and where N is the number of teeth simultaneously meshing with the complementary toothset. In the invention, the maximum driving force, corresponding to a driving power of 215 W and applied at a speed of the order of 3.3 m/s is equal to 65N. The surface area to which the driving force is applied to a tooth is equal to S=l×h, where l and h are respectively the length and height of the tooth, expressed in mm. Finally, the number N of teeth simultaneously in mesh, bearing in mind the diameter of the driving pinion, is estimated at N=2.67−0.33×p, where p is the pitch of the toothset, expressed in mm.

The uniform pressure is applied to the first or the second side, emanating from the crest of the tooth and forming the smaller angle, in the case of an asymmetric tooth. The side subjected to the uniform pressure is referred to as the driving side or driving face. The side not subjected to the uniform pressure is referred to as the non-driving side or non-driving face. In the case of an asymmetric tooth, it is advantageous for the uniform pressure thus to be applied to the side with the smallest angle, namely for the driving side to have the smallest angle. This allows transmission of a driving torque higher than that obtained with a symmetric tooth profile, namely one in which the angles of the first and second sides are equal. This is because an asymmetric profile leads to less flexing of the tooth than a symmetric profile, therefore allowing a greater load to be transmitted.

The maximum value of the ratio d/h between the displacement d of the crest of the tooth and the height h of the tooth, for determining the threshold Young's module E*ₛ is taken to be equal to 0.2 in order to guarantee minimal flexural rigidity of the tooth under the action of the uniform pressure, resulting from a driving torque, generally between 20 Nm and 50 Nm, and which may be as high as 60 Nm. The result of this is that contact between the deformed tooth and the nondeformable complementary toothset is maintained, thereby ensuring that the driving torque is transmitted.

Advantageously, the height h of the teeth is at least equal to 0.6 mm and at most equal to 3 mm.

More advantageously still, the length l of the teeth is at least equal to 0.15 times and at most equal to 0.50 times the section width S of the tire. The section width S of the tire is the axial distance, measured parallel to the axis of rotation of the tire, between the axially outermost points of the sidewalls of the tire, the tire being mounted on its rim and inflated to its service pressure, under the provisions of the standards of the European Tire and Rim Technical Organization or ETRTO.

These ranges of respective values for the height h and the length l of the teeth imply that the area of contact between a tooth of the toothset of the tire and a tooth of the complementary toothset of the pinion of the electrical assistance device, with which toothset the toothset of the tire is intended to collaborate, is comprised within a range of values that allows the driving torque generated by the electrical assistance device to be transmitted to the wheel. These ranges of values for the height h and the length l also take into consideration constraints on the space available for positioning the toothset on the sidewall of the tire.

The pitch p of the toothset is advantageously at least equal to 1.8 mm and at most equal to 5.5 mm. The pitch p of the toothset is the distance measured between the crests of two consecutive teeth, in a plane perpendicular to the generatrix.

It has been found that the higher the pitch of the toothset, the more noise it generates. By contrast, a higher pitch is more tolerant to a misalignment between the toothset of the tire and the complementary toothset of a pinion. Furthermore, a higher pitch is less sensitive to the presence of foreign bodies such as, for example, snow or mud, which are more easily removed. On the other hand, a shorter pitch is quieter, but less tolerant to misalignment or to the presence of foreign bodies. The recommended range of values for the pitch of the toothset thus makes it possible to obtain a toothset that is efficient in transmitting torque, relatively quiet and tolerant to a misalignment or to the presence of foreign bodies.

The pitch p of the toothset is more advantageously still at least equal to 2 mm and at most equal to 3 mm. This preferred range of values for the pitch of the toothset makes it possible to optimize the compromise between efficiency, noise and tolerance to the environment of the toothset. By way of example, a toothset pitch of 2.3 mm has yielded good results against this compromise.

It is also advantageous for the generatrix of the toothset to form, with the direction of the radial plane tangential to the axially exterior face of the sidewall, an angle at least equal to 4° and at most equal to 40°. This angle corresponds to the helix angle of the helically shaped toothset.

This inclination of the generatrix of the toothset with respect to the direction of the radial plane tangential to the axially exterior face of the sidewall increases the contact ratio for contact between the toothset of the tire and the complementary toothset of the pinion. Thus, the noise generated is appreciably reduced in comparison with a toothset of strictly radial generatrix, which means to say one that forms a zero angle with respect to the radial direction.

It is even more advantageous still for the generatrix of the toothset to form, with the direction of the radial plane tangential to the axially exterior face of the sidewall, an angle at least equal to 15° and at most equal to 30°. An angle of 25° is a configuration that is particularly advantageous in terms of the noise generated.

Advantageously, the first and second sides of the substantially triangular section of each tooth have a rectilinear profile. This is because a rectilinear side has a larger area for contact with the complementary toothset and therefore allows a higher torque to be transmitted.

More advantageously still, the first and second sides of the substantially triangular section of each tooth have a curvilinear profile. This is because curvilinear sides make it possible to increase the flexural rigidity of the tooth and therefore transmit a higher torque.

The driving and non-driving sides may also have a profile that combines rectilinear and curvilinear parts in order to combine the aforementioned advantages.

The generatrix of the toothset may also be curvilinear, in order to increase the length of mesh in comparison with a generally rectilinear generatrix, hence potentially increasing the torque that can be transmitted.

According to one preferred embodiment, the toothset contains a textile material, preferably of aliphatic polyamide type.

The textile material is preferably aliphatic polyamide or nylon, which is a material commonly used in the field of tires because of its cost and its compatibility with elastomeric materials.

A textile material often takes the form of a woven fabric. However, it may equally be made up of dispersed reinforcers.

The presence of a textile material, in addition to the elastomeric material, improves the abrasion resistance of the toothset, resulting from the meshing cycles. It also makes it possible to reduce the noise generated through a damping effect that the textile material has. Finally, from a manufacturing standpoint, a textile material, having orthotropic elasticity, follows the deformations during the moulding of the shape of the tooth as the tire is being formed during the curing thereof.

According to a preferred alternative form of the preferred embodiment, the toothset comprises, axially on the outside of the elastomeric material, a textile material, preferably of aliphatic polyamide type.

A textile material positioned on the outside of the elastomeric material offers the advantage of being easy to put in place. Furthermore, it makes it possible to increase the efficiency of the transmission by offering better slip between the toothset of the tire and the corresponding toothset, thus reducing friction losses through a lubricating effect.

The features and other advantages of the invention will be better understood from the appended figures which are schematic and not drawn to scale:

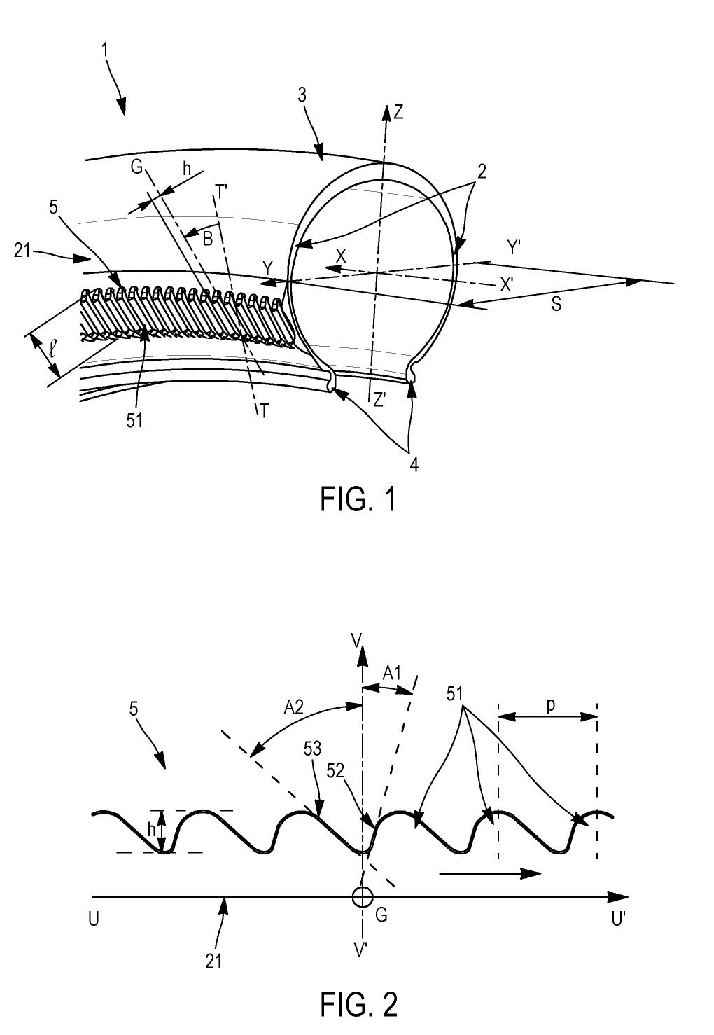

FIG. 1: a perspective view of a portion of a bicycle tire comprising a toothset according to the invention,

FIG. 2: a view in section of a toothset according to the invention, in a plane of section perpendicular to the generatrix of the toothset,

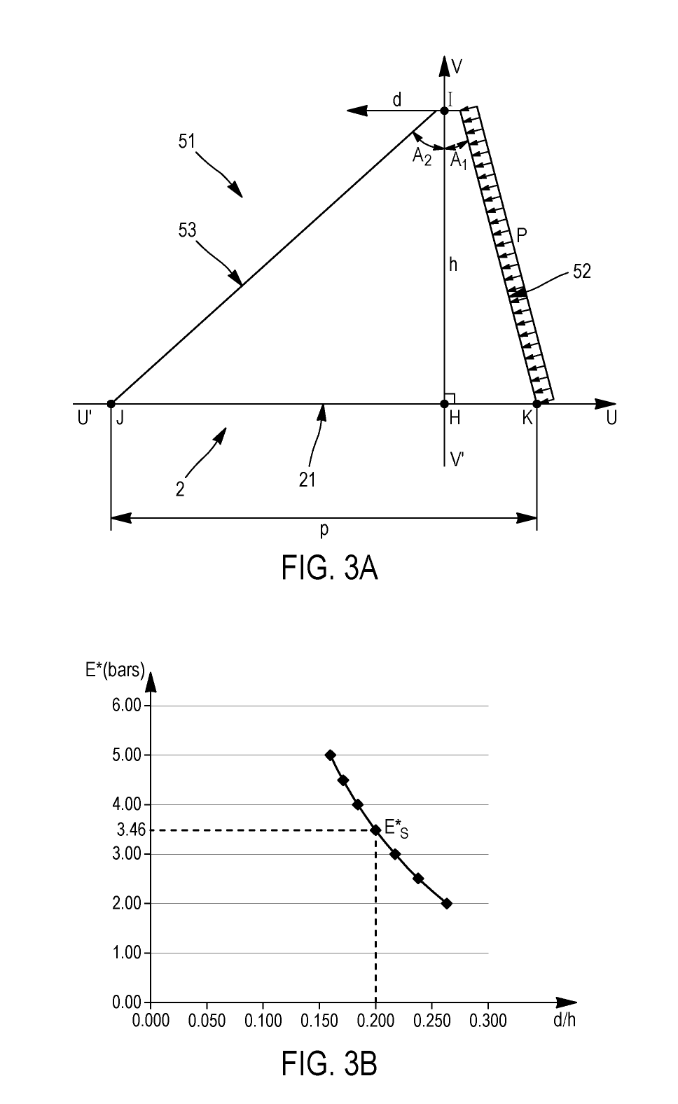

FIG. 3A: a view in section of a first example of a tooth with rectilinear sides,

FIG. 3B: how the Young's modulus E* of the elastomeric material changes as a function of the ratio d/h of the displacement of the crest of the tooth in the case of the first example of a tooth depicted in FIG. 3A,

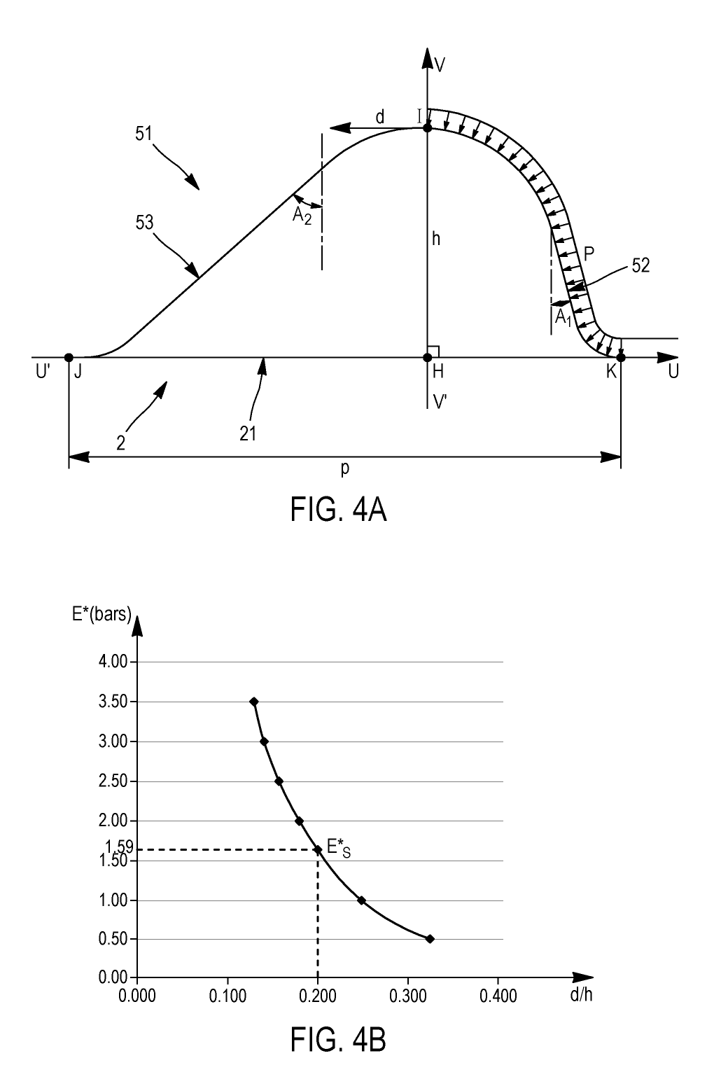

FIG. 4A: a view in section of a second example of a tooth with rectilinear sides and a rounded crest,

FIG. 4B: how the Young's modulus E* of the elastomeric material changes as a function of the ratio d/h of the displacement of the crest of the tooth, in the case of the second example of a tooth depicted in FIG. 3B.

FIG. 1 shows a portion of tire 1, comprising a toothset 5 according to the invention. The tire 1 comprises two sidewalls 2 connecting a tread 3, which is intended to come into contact with the ground (not depicted), to two beads 4 which are intended to come into contact with a mounting rim (not depicted). The directions XX′, YY′ and ZZ′ respectively denote the circumferential direction tangential to the tread 3 of the tire and oriented in the direction in which the tire runs, the axial direction parallel to the axis of rotation (not depicted) of the tire, and the radial direction perpendicular to the axis of rotation of the tire. The tire 1 has a section width S, measured in the axial direction YY′, between the axially outermost points of the axially exterior faces 21 of the sidewalls 2. The tire 1 comprises a continuous toothset 5, of generatrix G substantially radial with respect to the axis of rotation of the tire of axial direction YY′, positioned circumferentially, in the direction XX′, on an axially exterior face 21 of at least one sidewall 2. The generatrix G forms an angle B with the direction TT′, positioned in the radial or meridian plane YZ and tangential to the axially exterior face 21 of the sidewall 2. The toothset 5 comprises teeth 51 having a height h and a length l, the teeth 51 comprising an elastomeric material having an elastic shear modulus G*.

FIG. 2 is a section of a toothset 5 according to the invention, in a plane of section UV perpendicular to the generatrix G of the toothset 5. The toothset 5 is made up of a juxtaposition of teeth 51 which are spaced by a constant pitch p. The pitch p is the distance measured between the crests of two consecutive teeth 51 in the direction UU′ parallel to the axially exterior face 21 of the sidewall 2. Each tooth 51 has a height h, measured between the root and the crest of the tooth 51, in the direction VV′ perpendicular to the axially exterior face 21 of the sidewall 2. Each tooth 51 comprises a driving face or driving side 52 and a non-driving face or non-driving side 53. In the embodiment depicted in FIG. 2, the angle A₁ of the driving face 52, with respect to the direction VV′, is less than the angle A₂ of the non-driving face 53, with respect to the direction VV′. Furthermore, FIG. 2 illustrates teeth comprising rectilinear driving and non-driving faces. In the case of a curvilinear face, the angle described above needs to be measured between the tangent to the point on the curvilinear face that corresponds to half of the height of the tooth with respect to the direction VV′.

FIGS. 3A and 4A are views in section of a tooth 51 according to the invention, in a plane of section UV perpendicular to the generatrix G of the toothset 5. Each of the teeth depicted in FIGS. 3A and 3B respectively has a substantially triangular section IJK comprising a first and a second side (IK, IJ) emanating from a first vertex I, referred to as the crest of the tooth, and a third side JK opposite the first vertex I and positioned on the axially exterior face 21 of the sidewall 2. The first and second sides (IK, IJ) respectively form, with the direction (VV′) perpendicular to the third side JK, a first and a second angle (A₁, A₂). In the examples depicted, the first side IK is the driving side or driving face 52 of the tooth 51, to which the uniform pressure P is applied, and the second side IJ is the non-driving side or non-driving face 52 of the tooth 51, not subjected to the uniform pressure P. The first angle A₁ of the first side IK is less than the second angle A₂ of the second side IJ. The pitch p of the toothset is equal to the length of the third side JK. The distance between the crest I of the tooth 51 and its orthogonal projection H onto the third side JK defines the height h of the tooth 51. d is the displacement of the crest I, when the driving face 52 of the tooth 51 is subjected to the uniform pressure P. Only the non-deformed initial state of the tooth 51 is depicted in FIGS. 3A and 4A.

FIGS. 3B and 4B respectively depict the curves of how the Young's modulus E* changes as a function of the ratio d/h of the displacement d of the crest of the tooth to the height h of the tooth, for the teeth depicted in FIGS. 3A and 4A respectively. These curves make it possible, in each instance, to deduce the threshold value E*ₛ of Young's modulus that corresponds to a d/h ratio equal to 0.2. In other words, this threshold value corresponds to a tooth deformation of 20%.

Several configurations of toothset, of which the design has been optimized using finite element simulations, were the subject of experimentation by the inventors for a bicycle tire of size 37-622.

The first example of tooth, depicted in FIGS. 3A and 3B, is defined by the following characteristics:
toothset pitch p=1.8 mm
tooth length l=8 mm
tooth height h=1.22 mm
first angle A₁=16°
second angle A₂=48°
uniform pressure P=32.1 bar (deduced from the formula P=650/(l×h×(2.67−0.33p))

Table 1 below gives the results of the finite element numerical simulations performed on this first example of tooth:

TABLE 1

| Young's modulus (bar) | displacement d/height h |
|---|---|
| 2.00 | 0.262 |
| 2.50 | 0.236 |
| 3.00 | 0.215 |
| 3.50 | 0.198 |
| 4.00 | 0.183 |
| 4.50 | 0.170 |
| 5.00 | 0.159 |

The threshold Young's modulus E*ₛ, corresponding to a d/h ratio of 0.2, is 3.46 bar. Therefore the threshold elastic shear modulus G*ₛ is equal to 3.46/3=1.15 bar. In conclusion, the elastic shear modulus of the elastomeric material of the tooth needs at least to be equal to 1.15 bar, for this first tooth geometry.

The second example of tooth, depicted in FIGS. 4A and 4B, is defined by the following characteristics:
toothset pitch p=2.3 mm
tooth length l=8 mm
tooth height h=0.94 mm
first angle A₁=17°
second angle A₂=42°
uniform pressure P=45.2 bar (deduced from the formula P=650/(l×h×(2.67−0.33p))

Table 2 below gives the results of the finite element numerical simulations performed on this first example of tooth:

TABLE 2

| Young's modulus (bar) | displacement d/height h |
|---|---|
| 0.50 | 0.323 |
| 1.00 | 0.243 |
| 1.50 | 0.201 |
| 2.00 | 0.174 |
| 2.50 | 0.153 |
| 3.00 | 0.138 |
| 3.50 | 0.125 |

The threshold Young's modulus E*ₛ, corresponding to a d/h ratio of 0.2, is 1.59 bar. Therefore the threshold elastic shear modulus G*ₛ is equal to 1.59/3=0.53 bar. In conclusion, the elastic shear modulus of the elastomeric material of the tooth needs at least to be equal to 0.53 bar, for this second tooth geometry.

The invention has essentially been described in the case of a toothset intended to transmit a given level of driving force using a given geometry of toothset, in the case in which the toothset is made of an elastomeric material alone where the focus has been on optimizing the elastic shear modulus G* of this material. The use of a textile material in addition to the elastomeric material will contribute to increasing the shear rigidity of the tooth, which is then made up of an elastomer/textile composite material which means that it may be possible to lower the elastic shear modulus G* of the elastomeric material thereof. Moreover, the relationship expressing the uniform pressure applied as a function of the driving force, of the geometry of the toothset and of the number of teeth simultaneously in mesh may of course be adapted according to the maximum driving torque that is to be transmitted and according to the geometry of the complementary toothset of the driving pinion of the electrical assistance device, which governs the number of teeth simultaneously in mesh.

1. A bicycle tire comprising:
two sidewalls connecting a tread to two beads;
a continuous toothset, of generatrix (G) substantially radial with respect to the axis of rotation of the tire of axial direction (YY′), positioned circumferentially on an axially exterior face of at least one sidewall, and intended to collaborate with a complementary toothset;
the toothset being made up of teeth that are equidistant by a pitch p;
each tooth having a length l, in the direction of the generatrix (G), and a substantially triangular section (IJK) in a plane (UV) perpendicular to the generatrix (G),
the substantially triangular section (IJK) comprising a first and a second side (IK, IJ) emanating from a first vertex (I), referred to as the crest of the tooth, and a third side (JK) opposite the first vertex (I) and positioned on the axially exterior face of the sidewall;
the first and second sides (IJ, IK) respectively forming, with the direction (VV′) perpendicular to the third side (JK), a first and a second angle (A₁, A₂),
the distance between the crest (I) of the tooth and its orthogonal projection (H) onto the third side (JK) defining the height h of the tooth;
each said tooth comprising an elastomeric material having an elastic shear modulus G*,
wherein the elastic shear modulus G* of the elastomeric material of the teeth is at least equal to a threshold elastic shear modulus G*ₛ, the threshold elastic shear modulus G*ₛ being such that the displacement d of the crest (I) of each said tooth is equal to 0.2 times the height h of the tooth under the action of a uniform pressure P applied by the complementary toothset to the side (IK, IJ) that forms the smallest angle (A₁, A₂), equal to 650/(l×h×(2.67−0.33×p)).

2. The bicycle tire according to claim 1, wherein the height h of the teeth is at least equal to 0.6 mm and at most equal to 3 mm.

3. The bicycle tire according to claim 1, the tire having a section width S, wherein the length l of the teeth is at least equal to 0.15 times and at most equal to 0.50 times the section width S of the tire.

4. The bicycle tire according to claim 1, wherein the pitch p of the toothset is at least equal to 1.8 mm and at most equal to 5.5 mm.

5. The bicycle tire according to claim 1, wherein the pitch p of the toothset is at least equal to 2 mm and at most equal to 3 mm.

6. The bicycle tire according to claim 1, wherein the generatrix (G) of the toothset forms, with the direction (TT′) of the radial plane (YZ) tangential to the axially exterior face of the sidewall, an angle (B) at least equal to 4° and at most equal to 40°.

7. The bicycle tire according to claim 1, wherein the generatrix (G) of the toothset forms, with the direction (TT′) of the radial plane (YZ) tangential to the axially exterior face of the sidewall, an angle (B) at least equal to 15° and at most equal to 30°.

8. The bicycle tire according to claim 1, wherein the first and second sides (IK, IJ) of the substantially triangular section (IJK) of each said tooth have a rectilinear profile.

9. The bicycle tire according to claim 1, wherein the first and second sides (IK, IJ) of the substantially triangular section (IJK) of each said tooth have a curvilinear profile.

10. The bicycle tire according to claim 1, wherein the toothset contains a textile material.

11. The bicycle tire according to claim 10, wherein the textile material is of aliphatic polyamide type.
